(19) United States
(12) Patent Application Publication
(10) Pub. No.: US 2007/0073888 A1
(43) Pub. Date: Mar. 29, 2007

(54) System and method to control transactions on communication channels based on universal identifiers

(76) Inventor: Ajay Madhok, Haryana (IN)

Correspondence Address: PEDERSEN & COMPANY, PLLC, P.O. BOX 2666, BOISE, ID, 83701, US

(21) Appl. No.: 11/418,890

(22) Filed: May 6, 2006

(30) Foreign Application Priority Data
Sep. 26, 2005 (IN) 2587/DEL/2005

(51) Int. Cl. G06F 15/16

(52) U.S. Cl. 709/227

(57) ABSTRACT

The present invention is a method to control communication channels using universal and persistent identifiers in circuit/packet switched or converged networks. The method involves linking domain specific addresses or concrete identifiers of communication end points within or across channels, domains and networks with an abstract, persistent and universal identifier that represents the single point of contact or principal identity of the user. The principal identity can specify parameters of inbound/outbound communication relationships with other specified/unspecified users/entities inter-alia through default/specific levels of control in communication relationships on/across/through normal or alternate channels, domains, applications, networks, etc., based on universal/persistent identifiers such as XRI. All transactions originating from, or terminating on, the principal identity are authenticated, asserted securely and routed automatically to an appropriate channel based on the principal identity's current context (state, location, presence, etc.) and privileges (or contracts) defined in rules created by the principal identity for access, usage, privacy, synchronization, compliance, expiry, etc. The principal identity is also empowered with multi-level control over attributes and metadata including rules for what data to expose/share and what data to eclipse/hide for which user. Control/user data, or traffic, and program/client/sequence logic, may be resident/executed/exchanged/carried on, or across, diverse networks/channels/media/devices/domains etc.

This application claims priority of India Patent Application 2587/DEL/2005, filed Sep. 26, 2005.

### BACKGROUND OF THE INVENTION

1. Field of the Invention

The invention relates generally to communication systems and networks, including circuit switched, packet switched and converged networks. In particular, the present invention relates to providing a system and method of communication with fine-grained control before, during and after various transactions (that includes, but is not limited to, access, compliance, expiry, privacy, synchronization and usage control) between physical or logical end points within or across domains, channels, networks based on abstract, persistent and universal identifiers.

2. Description of the Prior Art

Traditionally there are two domains of communication—data packet based communication using Internet based addresses and circuit based communication using E.164 based addresses. Also there is the emerging domain of converged networks.

In packet based (also called packed switched) communication systems, using Internet Protocol (IP), entities (computers, switches, routers, gateways, devices, etc.) attached to the network are identified by IP Addresses. These IP Addresses correspond to a 32 bit integer for IP version 4 or 128 bit integer for IP version 6. Although these integers for IP Addresses provide a compact, and convenient representation for specifying source and destination for the packets sent across the network, human users prefer to assign entities easy-to-remember and pronounceable names. This scheme required a mapping between such assigned names and IP Addresses for communication to take place. Domain Name System (DNS) was developed to provide a scheme for assigning meaningful, high level names or identifiers to a large set of entities, and to provide a mechanism that resolves or maps high-level names to corresponding IP Addresses.

Packet based communication applications, e.g. email, instant message (IM), voice over IP (VoIP), use URI (RFC 2396) based addressing schemes as an identifier for the end user or system. DNS Servers are used to map these URI based addresses to IP Addresses. The identifiers issued by various applications are not compatible or usable in other applications (For example—A telephone number cannot be used as an IM handle) as these identifiers are application and sometimes service provider dependent. Because of this reason, a user ends up with different identifiers for different applications, such as email, IM, and VoIP etc. This fact is true even for the same application. For example, a user using IM services from Yahoo, Microsoft (MSN), America on Line (AOL) etc. ends up having multiple identifiers for these service providers. Another example application is email; where a user has multiple email addresses such as personal, office, web mail etc. Since such addresses/identifiers are not persistent (people change jobs, service providers, applications), communicating any changes to others and keeping track of changes in other's addresses/identifiers remains a challenge.

Packet based communication networks include, but are not limited to, the Internet, the Internet 2, Cable TV networks, 2.5G-3G wireless data networks and its future versions, WiFi, WiMax, xMax, and wireline broadband networks. Any packet based network using IP version 4/6, or a packet based network that can be connected to an IP network using any gateway(s) is included for, but is not the only, perspective of the present invention.

FIG. 1 is a block diagram schematically illustrating the working of various identifiers in packet based communication systems. In the said figure, the identity represents a user that has different identifiers for various applications. Any such user could also have multiple distinct identifiers for the same application. Further, the figure also illustrates the problem of unifying various identifiers of/for a single identity.

In circuit based (also referred to as circuit switched) communication systems, routing of telephone calls is based on a structured telephone numbering plan. These structured numbering and routing rules are defined by the International Telecommunication Union (ITU) in the E series standard E.164, which is a numbering scheme that is applicable in all domains of telecommunication systems, including wireless and wireline systems. Each end device (subscriber effectively) is usually identified by a 10 digit integer (excluding country code).

With ever increasing need for staying connected, anytime, anywhere, people have multiple telephone numbers associated with them such as mobile, home, office, fax etc. Although, people store numbers associated with their contacts in their phone books, electronically or on paper, the network does not have the ability to link these numbers to a(ny) single person or identity. And, when these numbers change (even with LNP, office numbers are associated with an organization and not with a person), it becomes very cumbersome to communicate these changes to contacts, or to contact someone (affected by any changes) if the change particulars are not known.

FIG. 2 is a block diagram schematically illustrating functioning of various identifiers in circuit based communications networks. The said figure illustrates that a single identity can have different telephone numbers such as personal phone number, mobile number, fax number, office telephone number etc. But there is no system, method or apparatus in the network to link all such numbers to a single identity.

FIG. 3 is a block diagram illustrating the functioning of Local Number Portability. Local Number Portability (LNP) is the ability of a telephone customer to retain the local phone number even upon changing to another local telephone service provider. However, LNP is limited to the circuit based communication system only and is limited to the boundaries of a particular country only, and thus has no universal applicability. ENUM is a protocol used to provide LNP, but it cannot provide IM address or email ID portability.

Both, packet switched and circuit switched, systems have a common deficiency of lack of persistence and universality of addresses/identifiers. Due to this, a problem with such addressing schemes, in packet switched and circuit switched domains, is to communicate and manage changes in an(y) address/identifier. If communication addresses/identifiers corresponding to a person in both, packet switched network and circuit switched network, are looked at in totality, any change in these becomes hugely cumbersome and difficult to communicate. People need to communicate changes to everybody who had the address. Sometimes it is not even possible to ascertain who all have the previous address. The problem enounced is similar to knowing how many outstanding references exist to a web page, which if moved, will result in the familiar broken link Error 404 (Page Not Found).

Lack of knowledge about, or control over, other entities who may have/know an address or identifier(s) of a person presents its own problems in both, circuit switched and packet switched networks. A user loses control over any address or identifier that is given out to, or becomes known to, others. Once somebody knows a communication address, it can be targeted for sending unsolicited communications. Examples of such communications are email spam, IM spam, telemarketing through phone calls, SMS, MMS, etc. These problems are tackled differently in different domains, typically by defining access rules. However, these rules are predominantly based on the pair(s) of addresses/identifiers of involved end points, with white list (permit) and black list (prohibit) logic. In case of any changes in these addresses/identifiers, the problem needs to be tackled again and rules must be redefined. Often these rules are as basic or limiting as a binary decision (on/off) as in the case of telecommunication end points (telephones, mobile phones etc.). Even password screening is a binary situation—with permit (allow) or restrict (disallow) result.

FIG. 4 illustrates access control over communication channels associated with various addresses/identifiers of an identity. Unsolicited communications like email spam, IM spam, telemarketing phone calls, SMS, MMS, etc. are tackled differently in different domains, through separate access rules. The figure illustrates that each communication channel/domain/network typically has its own rules for access control, which may need to be redefined in case of any change in address/identifier.

Advanced access control can be based upon primary permission validation (friend/foe) combined with password control or other parameters such as time of day (phone calls), text parsing (emails), etc. but is again domain specific, based on changeable addresses/identifiers and ultimately results in a Boolean outcome of either allowing full access on a particular channel/domain/network or denying such access. A user may be available on many channels but may not wish to be accessible to everyone, on each channel, always. Communication transactions often originate from, or are directed to, inanimate entities such as automatic calls by an airline about ticketing and delays (which any traveler may wish to receive despite being incommunicado for everyone else) or SMS to, or from, a bank regarding a banking transaction (that may be very important for a person despite being silent on the mobile phone), etc. and may run across channels/domains/networks. Also, many communication transactions are generated because of attributes of a(ny) user that depict chosen preferences of such users (news/stock/weather updates by SMS, voice call, email etc.), demographic variables, or other characteristics. Users may wish to receive such communications in preference to other communication transactions. The converged network presents its own set of challenges with greater quality, quantity and variety of transactions increasing the complexity of the communications/e-life of users, who cannot blink out of any contemporary or emerging channels of communication.

Therefore, apparently there is a problem of inappropriate communication, improper timing, incorrect channel, and inadequate means of tackling such situations. Traditional control is often limited to the relevant channel domain, network, application etc. and vulnerable to volatility of communication addresses/identifiers; lacking differential access privileges, user context or preferences sensitivity, etc. that may extend across different channels. A user may wish to allow mobile access to a few while restricting it for others (in general or based on the choice/situation of the user) and the grant of privileges may extend across channels (block mobile, allow SMS, allow landline, allow email, block IM) with many variations based upon the context/preferences (block SMS while on travel but divert to email). The complexity of defining aggregate levels/privileges of direct/diverted access etc. for, and across, several channels, networks, applications, domains, etc. (with different addresses/identifiers), for multiple communication contacts, is an inherent impediment. Various addresses or identifiers are neither unique, nor interoperable, nor permanent, nor sensitive to context/preferences, nor linked, nor consistently synchronized/updated, etc. amidst the total perspective of control that is rather disjointed/constricted, with resultant problems related to access, usage, privacy, synchronization, expiry, and compliance control along with context/preference sensitivity across diverse communication channels and disparate addresses/identifiers that belong to a single user identity, or user entity.

Therefore, what is required is a system and method that obviates the above deficiencies and provides a system and method to control communications channels based on abstract, persistent, universal identifiers, which allow any user identity to define the parameters of the communication relationship that may exist vis-à-vis another user identity/entity, for/across various channels, networks, applications, domains etc. (and to so define, and/or set to default, for all possible communication relationships that a user identity may have), on a per relationship basis so that the control can be exercised/asserted in a fine grained manner.

### SUMMARY

An object of the present invention is to provide universality to communication addresses of a user identity by leveraging an abstract, universal, persistent identifier to encompass diverse identifiers representing any such user identity across different channels, domains, applications, networks, etc. (at various points in time).

Another object of the present invention is to provide persistent addressing, independent of underlying channels, networks, applications, domains, etc.

Another object of the present invention is to give to the principal identity, in various communication relationships with other users, fine-grained control.

Another object of the present invention is to allow the principal identity to set various privileges/levels of specific/default control in communication relationships.

Yet another object of the present invention is to empower a principal identity with multi-level control over sharing of attributes/metadata including, but not limited to, preferences or parameters like state, presence, location, availability, profile, age, sex, hobbies, interests, dislikes, affiliations, etc. on a per relationship basis, at a chosen level of granularity and take away/expire/change those privileges or shared attributes based on his temporal context. The sharing/hiding of his attributes/data may vary depending on the requestor and the current context of the requestor and/or principal identity.

A further object of the present invention is to provide number independence and/or invariance of abstract, persistent, universal identifier across different networks, domains, geographies, etc. for communication transactions and minimizing any disruptive effect of change in any of the underlying identifiers representing the principal identity by handling such changes for various communication relationships of the principal identity.

### Definitions and Presumptions

In this description, the words principal, responder, receiver are synonymous in usage. The words caller, requester, sender are synonymous in usage. A principal/receiver in one scenario may be a caller/sender with respect to another scenario, or reference-point, and the words user or identity, though largely used to refer to the principal, also represent the connotation of the caller in general. Any sender(s) and/or receiver(s) may be, without limiting generalization of the expression, an animate and/or inanimate user/entity (or combination thereof), with/without embedded/programmed/controlled/external/inherent intelligence, and/or logic, and/or other functionality. The singular includes the plural and vice-versa. Phrases are gender neutral.

### BRIEF DESCRIPTION OF THE DRAWINGS

FIG. 1 is a block diagram that illustrates the working of various identifiers/addresses in a communication network based on packet switched system (prior-art).

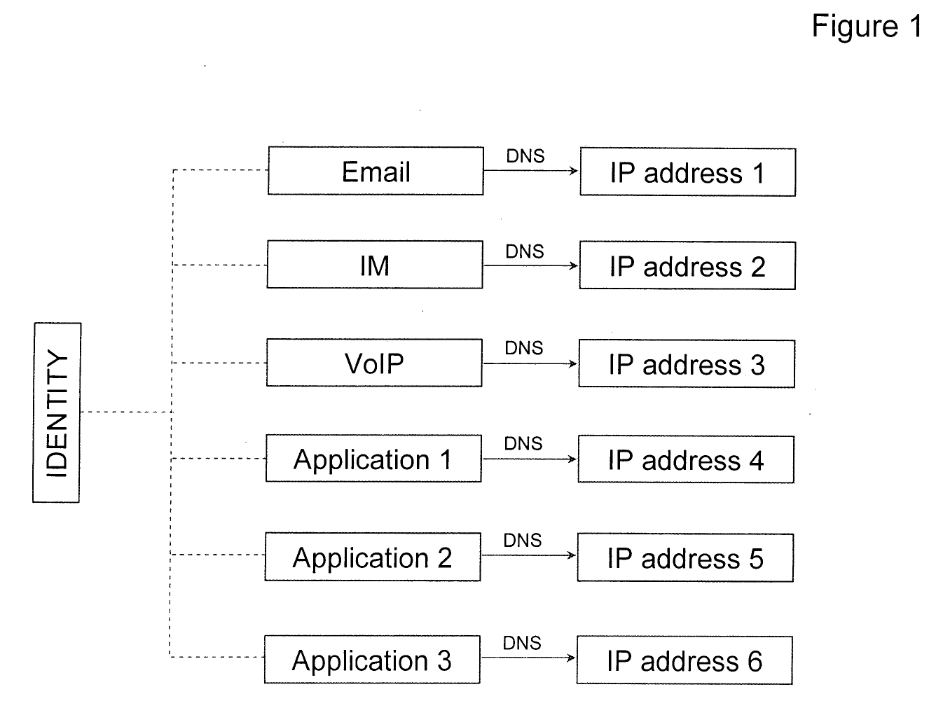

FIG. 2 is a block diagram that illustrates the working of various identifiers/addresses in a communication network based on circuit switched system (prior-art).

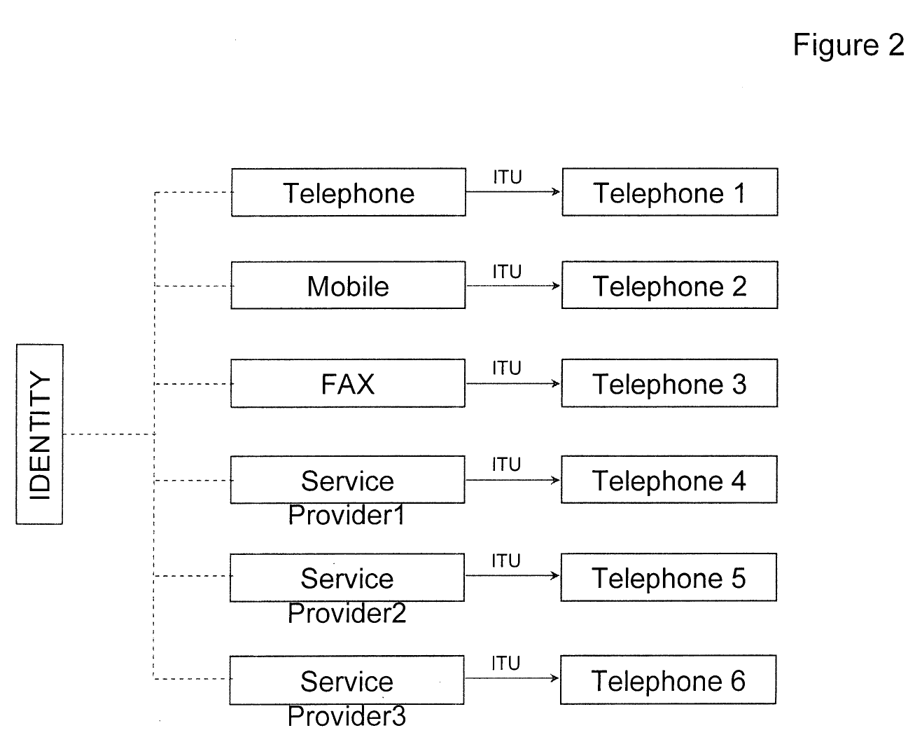

FIG. 3 is a block diagram illustrating the functioning of Local Number Portability wherein a subscriber can change a service provider and yet retain his number (prior-art).

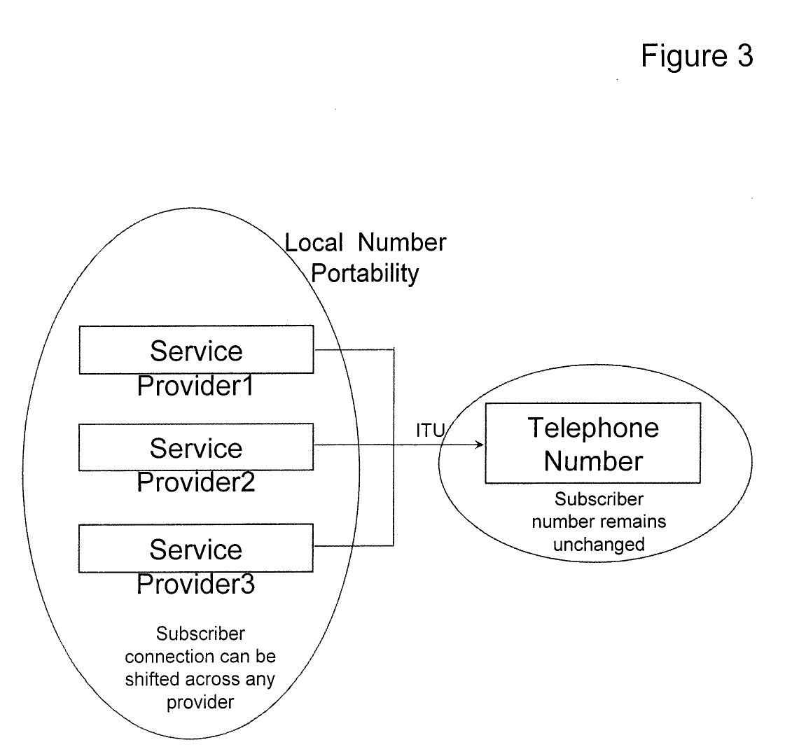

FIG. 4 is a block diagram that illustrates provisioning of access control, over various communication channels associated with various addresses/identifiers, based on rule sets applicable on a per domain basis (prior-art).

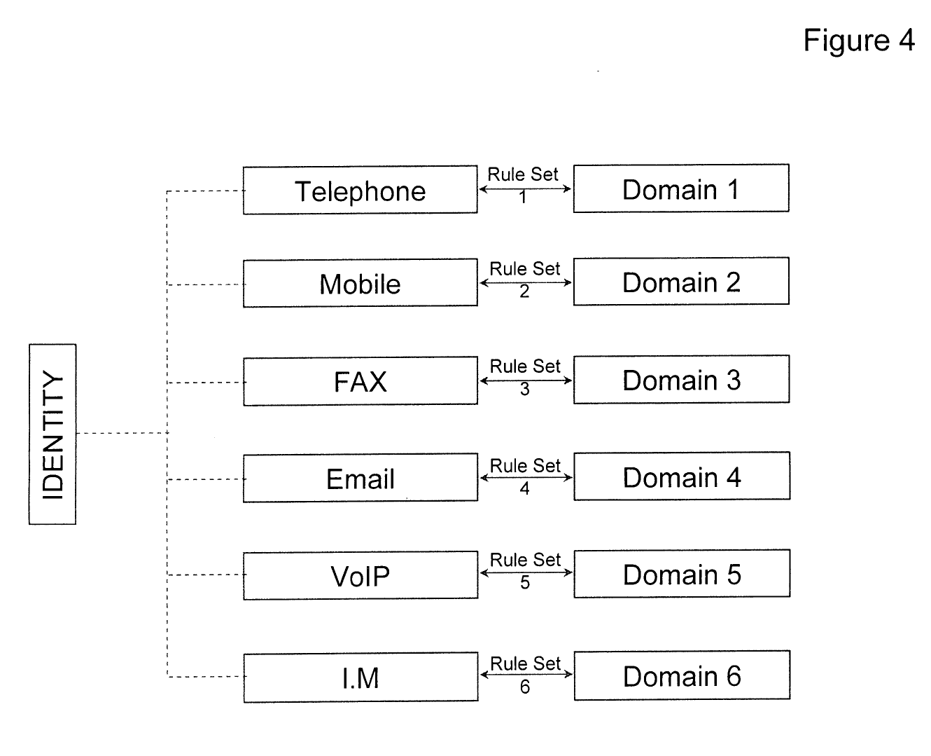

FIG. 5 is a block diagram that illustrates logical representation of an ‘abstract identifier’ (universal, abstract and persistent) as per an embodiment of the present invention (based on expansion of prior-art to create a privacy barrier for various communication addresses/identifiers of a user that can be linked/resolved by the abstract identifier) for initiating/establishing a communication transaction invoking the abstract identifier.

FIG. 6 is a flow chart that explains the call flow for a communication transaction between two identities as per an embodiment of the present invention.

FIG. 7 is a flow chart that illustrates the call flow for a communication transaction between two identities on the basis of the context of the principal and the relationship that exists between the two identities as per an embodiment of the present invention.

FIG. 8 is an illustration of the logic of single point of discovery of various parameters of an identity from its Discovery Service as per an embodiment of the present invention.

FIG. 9 is a sequence diagram that illustrates the sequence of steps for providing email spam control as per an embodiment of the present invention.

While the invention is amenable to various modifications and alternative forms, specific embodiments of the invention are provided as examples in the drawings and detailed description. It should be understood that the drawings and detailed description are not intended to limit the invention to the particular form disclosed. Instead, the intention is to cover all modifications, equivalents and alternatives falling within the spirit and scope of the invention as defined by the appended claims.

### DETAILED DESCRIPTION

The present invention is directed towards providing a system and method, for circuit switched, packet switched as well as converged networks, to control transactions between users/entities based on abstract, universal, persistent identifiers that are independent of channel, domain, applications, networks, etc. and are used as a single point of contact for the principal identity for communications and data interchange, encompassing underlying addresses/identifiers. The usage of such identifiers bridges fragmentation in identifying the ‘principal’. The present invention introduces usage of identifiers that are universal, interoperable across domains and network boundaries, compatible with URI and IRI, and are persistent; for all transactions including communication and exchange of data about the principal. Usage of such identifiers also provides immunity from changes in domain specific communication end point(s) because of various reasons—e.g. locality change, domain change, operator change, organization change, application changes, etc. The solution works due to the fact that the end point address resolution is done dynamically during the phase of establishing communication. For the present invention any identifier scheme that meets the above requirements can be used. XRI by OASIS and ‘The Handle System’, Persistent URL (PURL) etc. are few such standards. These identifiers are obtained from the identity provider as specified by individual standards/technologies. The procedure of registering for such an identifier and provisioning the necessary details is out of scope of this document. In this document, this identifier is mentioned as an ‘abstract identifier’ because in theory it is an abstraction of the existing identifiers and any abstract identifier can be resolved into the underlying concrete identifier(s).

In simple terms, the solution is based on trusted resolution of the abstract identifier into a user's concrete identifier based on who is asking for resolution and what is the temporal context of the user. The resolution process looks up privileges assigned to relationships or the asking end point(s), given the user's temporal context. In other words, this dynamic resolution of the abstract identifier to an appropriate concrete identifier (as determined by the user's policies and privileges for the requesting end point) provides the user control over the transaction—which channel and underlying concrete identifier should be used for communication.

Any change in an underlying domain specific address does not impact the transaction or the policies governing the transaction. The resolution of the abstract identifier gives the description about the principal identity itself along with authorities hosting related data and the references to the data that the ‘identity’ wishes to make public.

The trusted resolution authority is the ‘Discovery Service’ of the user that provides an interface (i.e.—API) for others to reach out to the user electronically (over a network) and acts as the local authority for resolution of the abstract identifier into a concrete identifier. The network based resolution process looks up the registry of a user's Discovery Service. The relevant service end point is made available by the registry in a manner quite akin to querying the DNS registry (using who is etc.) to get underlying records (URLs) of a DNS name. The Discovery Service has a programmatic interface to the user's Relationship, Context and Attribute authority(ies) as further described herein.

Examples of XRI based identifiers are as follows.

=user,
=user/(+phone)/(+home),
=user/(+phone)/(+mobile),
=user/(+phone)/(+office),
=user/(+email)/(+personal),
=user/(+fax)/(+home),
=user/(+IM),
@company/(+ceo)/(+email),
@company/(+cto)/(+phone).

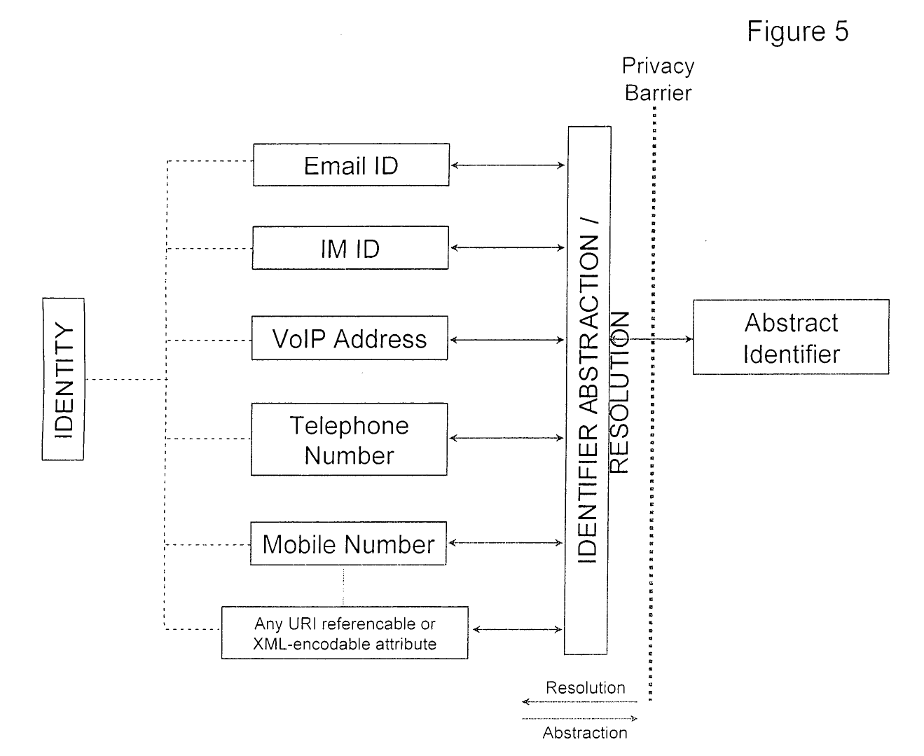

FIG. 5. is a block diagram illustrating logical representation of an ‘abstract identifier’. Such an abstract identifier can be used as a single point of contact for the user ‘identity’ and can encompass any concrete end point address(es) of the identity. As per one of the embodiments of the present invention, a request for a transaction can be invoked using the abstract identifier. The subject of the transaction, i.e. identity, can be addressed using the abstract identifier. As an example of such an embodiment of the present invention, a user ‘X’ can dial user ‘Y’ over the mobile phone using the abstract identifier of ‘Y’. The transaction first gets authenticated at the identity provider or a delegated ‘Authentication Authority’ for establishing a security context of ‘X’. The latter part of this transaction is to identify ‘Y’ and bridge the transaction between ‘X’ and ‘Y’. Here ‘X’ may be agnostic about the phone number of ‘Y’ but can reach ‘Y’ over his phone. Even if ‘Y’ changes his mobile number, ‘X’ can still reach him by dialing the abstract identifier of ‘Y’ since resolution of the mobile number of ‘Y’ is done by the abstract identifier based on the contact privileges specified by ‘Y’ vis-à-vis ‘X’ and the context information of ‘Y’ when ‘X’ calls. Finally, when ‘Y’ gets a call on his mobile phone the caller id that gets displayed is not the mobile number of ‘X’ but the abstract identifier of ‘X’. The usage of the abstract identifier thus helps in creating a privacy barrier. In another example, while sending an email, ‘X’ sends an email to ‘Y’ at the abstract identifier of ‘Y’. The email goes through processing and finally reaches the inbox of ‘Y’ who has an account—say ‘y@mydomain.com’. Such implementation requires that clients and servers should have the logic of resolving the abstract identifier.

As per an embodiment, the invention tackles the problem of misuse of communication end points by allowing the ‘principal’ to frame policies and rules on the access and usage of the identifiers as well as data that is pointed to by these identifiers. These policies and rules like ‘who can do or use what’ can be framed across applications, communication channels and even domains or networks. They can be applied across all kinds of transactions between two identities. Once defined, these rules remain unaffected even if the domain specific address changes. Every transaction between two identities is guided and guarded by these rules to establish a communication channel. These policies and rules are defined, or set to default, by the principal himself and are serialized as communication contracts between the two identities. These can be called as ‘commtracts’ that explain the communication policy between the two. A principal may have contract(s) with more than one identity; let us call them as ‘identity contacts’. These can be stored in an ‘abstract identifier’ enabled address book of the phone as any other normal contact. Broadly speaking the identities can be tagged with relationships like ‘friend’, ‘customer’, ‘family’, etc. By default there would always be one relationship that exists universally between any two identities; that is ‘public’. Unless a Relationship is specialized between any two identities the default relationship between the two is ‘public’. Unless a commtract is categorized/customized explicitly between the two identities the commtract for public relationship takes effect for such a transaction. A case where a principal tags an ‘identity contact’ as ‘friend’ but customizes the policy for him alone can also exist. In other words, the control before transaction ensures that the appropriate underlying concrete identifier is provided to the other end point for that transaction. This, at an absolute level, is equivalent to mediating data exchange between arbitrary end points, that may belong to different trust domains, using singular/reciprocal one-way contracts that define the terms of transactions/exchange. So the invention is easily applied to various domains, including but not limited to enterprise data exchange as well as financial transactions as the method invented provides a robust framework for value transfer or mediated data exchange between arbitrary end points.

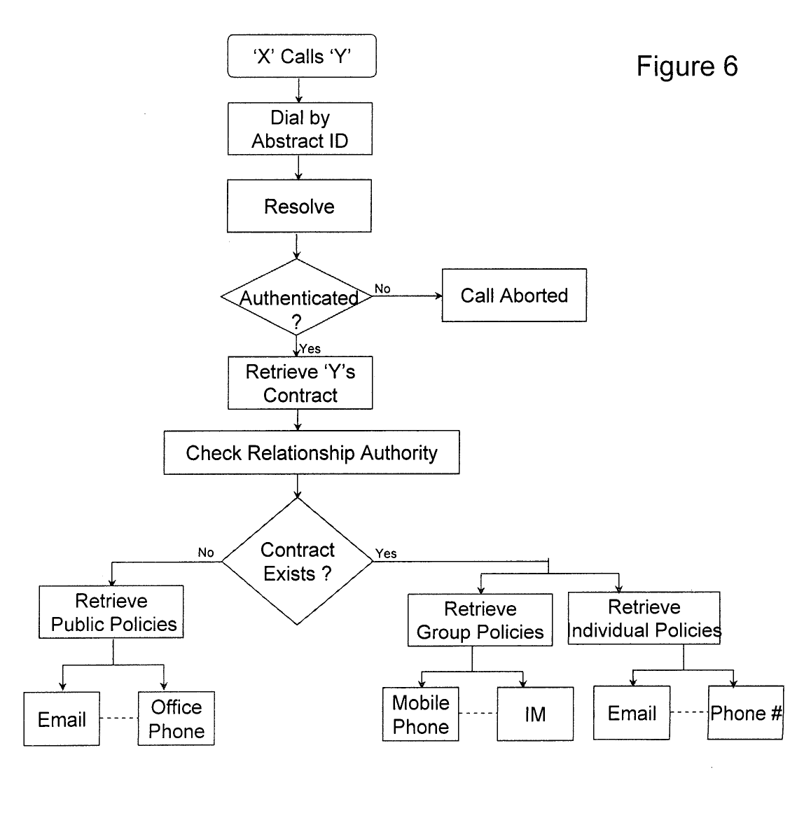

FIG. 6 is a block diagram illustrating access control over communication channels as per an embodiment of the present invention. FIG. 6 explains call flow of establishing a transaction between two identities. The identity ‘X’ calls the identity ‘Y’ using the abstract identifier of ‘Y’. Caller ‘X’ goes through an authentication process. Before the call reaches ‘Y’, the ‘Relationship Authority’ that holds relationships and commtracts of the identity ‘Y’ is queried in a secure way for existence of any relationship between ‘X’ and ‘Y’. Unless there is a specific relationship between the two identities the ‘public’ relationship applies. For any relationship the principal can specialize or categorize the commtract along with policies and rules such as—“friends can get my mobile number, home phone number and personal email but ‘public’ can get only ‘office email’ and ‘office phone’”.

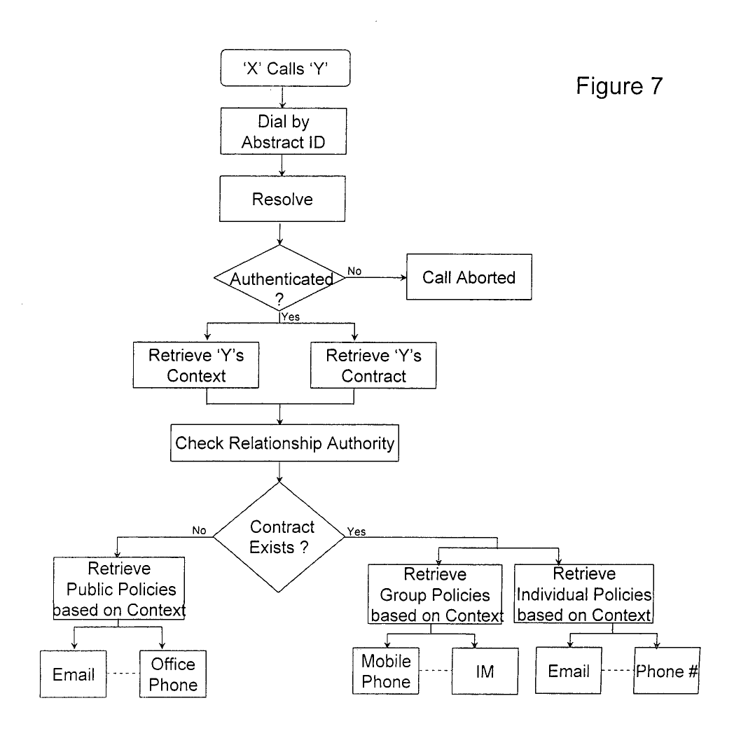

FIG. 7 is a block diagram illustrating access for identifiers being guided and guarded by both, per relationship basis and the context of the principal. As per another embodiment, access policies can be extended to also include the context information of the principal. The principal may establish a commtract with ‘friends’ such as—“if I am on ‘travel’ they can use only ‘email id’”, but “if members of my ‘family’ call then they should be able to reach me on my ‘mobile phone’”. The context of the user is taken from any ‘Context Authority’ of the relevant principal. The principal may set the context explicitly or it may be fed by different context feeders like mobile networks. The aforesaid narrative defines that context information of the user is located in a logical entity called ‘Context Authority’.

Similarly the principal can establish commtracts with the identity contacts for just data sharing. The data can include his attribute information or information about his ‘presence’ and ‘location’ data. As an example, the principal may give access about his presence information to his ‘family’ members but may obscure it or even disable this information for ‘public’. He may enable his colleagues to see his location while he is on a business trip but disable the location information for vendors in any airport(s) that he may be waiting in, or transiting through. The principal can set such types of fine-grained controls in a very simple and user friendly manner. The user can be allowed to specify, edit and delete commtracts related to his contacts and relationships from any client/device. The clients can be a Smart Phone, a Web Browser, a desktop client or even an ASR service. These rules are stored as ‘commtracts’ that can exist independent of the underlying transaction technology. If XRI is the identifier technology used, such contracts are classified as XRI Data Interchange (XDI) contracts. Identity contacts, Relationships and commtracts (user rules and policies) all are located in a logical entity called ‘Relationship Authority’.

As per one of the embodiments, the principal can exercise control over the transaction even during the process of a transaction. He can establish a new commtract during a call. Due to reasons of context and/or situation, the user may wish to modify the existing commtract on-the-fly.

For example: ‘Y’ has allowed ‘X’ to reach him on his mobile phone during his ‘Meeting’ hours but due to some reason when ‘X’ calls, ‘Y’ is not in a situation to take the call. Now ‘Y’ can divert the call on-the-fly to his Voice Mail system. This alters the commtract temporarily for that particular transaction.

As per one of the embodiments, the principal can initiate a commtract with another identity or he can be offered a request for a commtract by another identity. To initiate a commtract the principal can key in the abstract identifier on the client. The client will connect to the appropriate server to resolve the abstract identifier and add it to the identity contact list. The principal can now frame rules and save is as a commtract. If the abstract identifier of another user is not known, the principal can even query/search the server on various keywords to get the right identifier to refer to the identity. By default a ‘public’ relationship exists between any two identities. An ‘identity’ ‘X’ can tag ‘Y’ to any relationship i.e. make ‘Y’ a ‘colleague’, but the contract is partial, in the sense that ‘Y’ still has the default contract ‘public’ with ‘X’. ‘X’ can offer a request for a contract to ‘Y’ and it is at the discretion of ‘Y’ to accept the offer, deny the offer, negotiate the offer, or even keep the offer in a pending state. The recipient of the offer may choose to enquire more about the identity proposing the offer, i.e. ‘X’ by asking him to furnish more details in a manner akin to contract negotiation. Also, an offer can be made to ‘Y’ during the first transaction, as explained below.

The following example explains a hypothetical scenario of communication between two identities ‘X’ and ‘Y’ in a step by step sequence.

Step 1: ‘X’ obtains the abstract identifier of ‘Y’

Step 2: ‘X’ logs on to his account. The Application Server resolves the identity of ‘X’ by passing ‘who is X’ query to the Identity Authority of ‘X’. Application Server gets ‘X’ authenticated by the Identity Authority of ‘X’.

Step 3: ‘X’ dials ‘Y’ using the abstract identifier of ‘Y’

Step 4: Application Server looks for a contract of ‘X’ with ‘Y’ at ‘Y’s Relationship Authority. In absence of prior contract it routes/handles the call as per the default rules for a ‘public’ contract.

Step 5: If a contract exists between ‘X’ and ‘Y’, the call is routed to an appropriate channel based on ‘Y’s current state and the contract between ‘X’ and ‘Y’.

The hypothetical scenario where ‘X’ establishes a contract with ‘Y’ is listed below:

Step 1: ‘X’ obtains the abstract identifier of ‘Y’

Step 2: ‘X’ tries to add ‘Y’ into his contact list.

Step 3: ‘X’ associates a relationship (e.g.—‘colleague’, ‘friend’ etc.) with ‘Y’ and formulates rules for communication with him.

Step 4: ‘Y’ receives a pending invitation from ‘X’. ‘Y’ has the following options—

(a) Accept the invitation and add ‘X’ to his contacts:

‘Y’ also associates relationship with ‘X’ and set contract rules for him.

(b) Reject the invitation from ‘X’:

‘Y’ is removed from ‘X’s contact list. No contract exists between them.

Step 5: Once a commtract forms between ‘X’ and ‘Y’ (i.e. Y accepts X), all communication between ‘X’ and ‘Y’ is guided according the rules of the commtract.

Step 6: After a commtract is set-up, or been in existence, between ‘X’ and ‘Y’, the rules of commtract can be altered or changed. Assuming reciprocal grant of privilege(s) of access on mobile phone(s) in the contract relationship(s), the next few steps explain a hypothetical continuity of any of the previous two scenarios, as per the following incremental steps:

Step 7: ‘Y’ edits the commtract with ‘X’ saying “if ‘X’ calls and I am traveling, my preferred channel would be SMS”.

Step 8: Next time ‘X’ dials ‘Y’ by the abstract identifier while ‘Y’ is traveling.

Step 9: The Application Server looks at the Context Authority and gets the context of ‘Y’. It also looks at the Relationship Authority of ‘Y’ and gets the commtract existing between them.

Step 10: Applying both, the context and the commtract, to the transaction the Application Server sends back the message to the application client to open the appropriate channel, in this case the SMS editor of ‘X’.

Step 11: ‘X’ sends an SMS to ‘Y’. ‘Y’ receives the SMS message. The sender tag would have the abstract identifier of ‘X’.

The present invention not only covers control over inbound/outbound communication but also control over every transaction involving data about the identity. The data can be attributes, preferences, or parameters, such as state, presence data, location data, profile information (name, address, sex, age, preferences. likes, dislikes, etc.), etc.

From the above description it is evident that an ‘identity’ is supported by many authorities like Attribute Authority, Relationship Authority, Context Authority, etc. As per another embodiment of the present invention, there can exist various service providers who can become the ‘Authority’ for particular data of the user. Also these various ‘Authorities’ may be located across different networks or domains or use different application technologies.

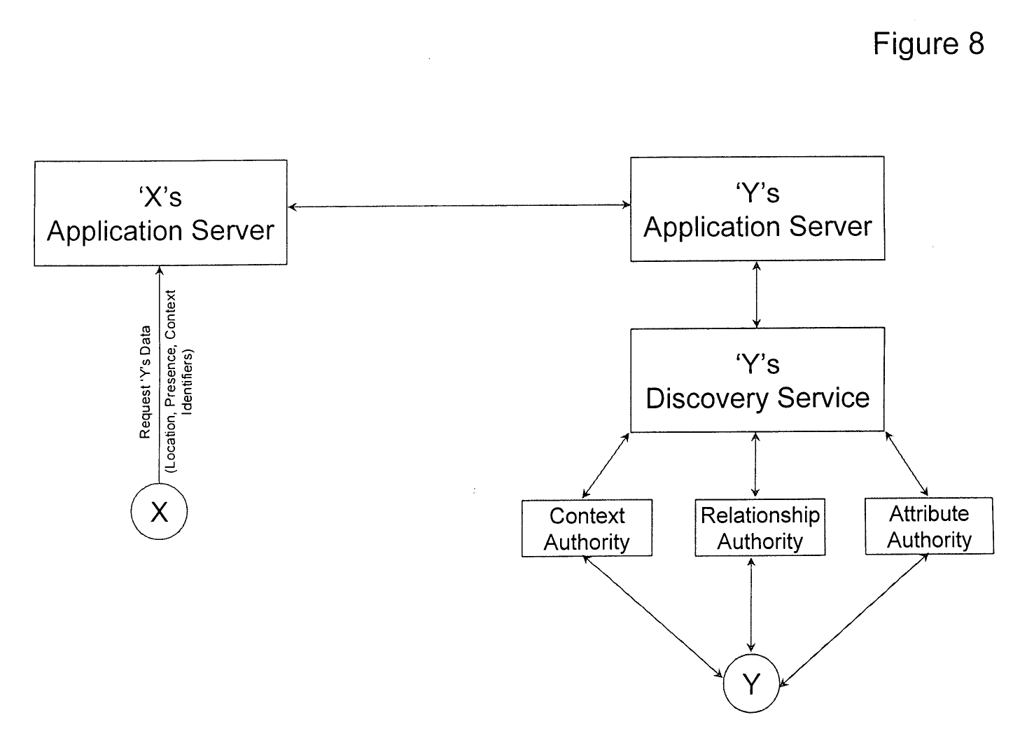

FIG. 8 illustrates the logic of discovering the identity from its Discovery Service. The invention proposes a meta-service by the name ‘Discovery Service’ which talks to the underlying authorities and becomes the single point of discovery of the identity. For any transaction request directed to an ‘identity’ the relevant Application Server approaches the Discovery Service of that ‘identity’ for handling the transaction. The invention assumes that the Discovery Service is built on the underlying identifier Scheme and exposes data discovery and update interface.

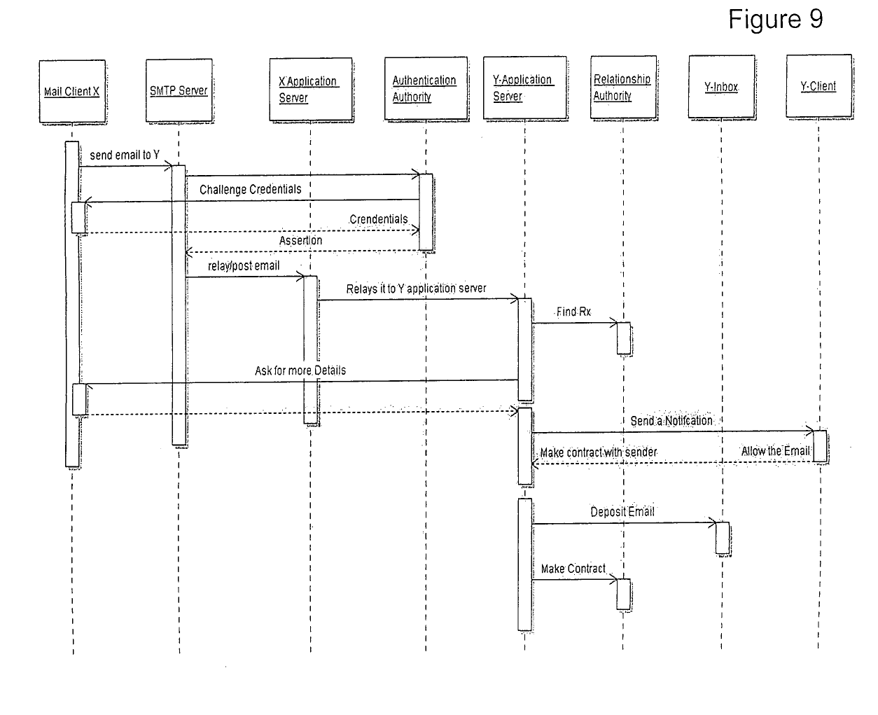

FIG. 9, which is a sequence diagram, illustrates steps involved in providing an effective email spam control solution using ‘abstract identifiers’, as per another embodiment of the present invention.

Step 1: ‘X’ sends an email to ‘Y’ using the abstract identifier of ‘Y’. The email is sent using the SMTP server provided for ‘X’.

Step 2: SMTP server gets ‘X’ authenticated using the Authentication Authority for ‘X’.

Step 3: After successful authentication and assertion by the Authentication Authority, the email is relayed to the Application Server of X. Here the email can be digitally signed by ‘X’s-SMTP server.

Step 4: ‘X’s Application Server resolves ‘Y’ and sends a secure relay to ‘Y’s Application Server.

Step 5: ‘Y’s Application Server queries the Relationship Authority of ‘Y’ for a commtract with ‘X’.

Step 6: If commtract exists already between ‘X’ and ‘Y’ (Contract can be to allow ‘X’ to send an email to ‘Y’), the mail is relayed to inbox of ‘Y’. If there is no contract, optionally ‘X’ may be asked to send more details about himself.

Step 7: ‘Y’ is notified briefly about the sender and a pending request for a commtract

Step 8: ‘Y’ approves the sender and the Application Server releases the email and deposits into inbox of ‘Y’.

Step 9: Application Server sends a request to Relationship Authority to establish a commtract between ‘X’ and ‘Y’.

This would block any unsolicited emails targeted at/to the principal's inbox. There can be various versions and methods for spam control. Another version of the same is to control spam on multiple public email accounts that support POP and IMAP access. The emails are polled and the ‘From’ identifiers are looked for. If the ‘From’ identifier cannot be mapped to the ‘abstract identifier’ then the sender is categorized as public and commtract with ‘public’ senders takes effect.

As per an embodiment of the present invention if two identities are served by different Application Servers, the request is communicated between the Application Servers using secure assertions. The invention proposes the usage of SAML 2.0 and above for achieving this. The assertion contains the authentication statement of ‘From’ identity, the attributes that ‘From’ identity needs to share with ‘To’ identity that are agreed in the commtract and the authorization statement. The SAML 2.0 assertion package consists of three statements—

1. Authentication statement asserting that the credentials of the end point have been verified by its certification/Identity Authority;

2. Authority statement asserting the contract reference;

3. Attribute statement providing all the attributes that the contract mandated or were required by the contract to be fulfilled.

The aforesaid embodiments are not limited by/to the procedures mentioned here. The extent of the present invention not only covers fine-grained control through commtract rules set before/during/after transactions over/across communication networks/channels based on abstract, universal, persistent identifiers but also control over all communication and mediated data exchange between arbitrary end points, that may belong to different trust domains, using reciprocal contracts that define the terms of transactions or exchange of data including, but not limited to, user attributes, preferences, or parameters, such as state, presence, location, availability, demographics, personal profile information (name, address, sex, age, likes, dislikes etc.), affiliation, groups, interests, vocations, status, repute, worthiness, electronic cash, value transfer, etc.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

I claim:

1. A method to provide a single, unified identity to a user having multiple communication identifiers, such method comprising:
encompassing multiple communication identifiers to a single point of contact, called principal identifier or principal identity;
providing context sensitive linkages between the principal identity and the said communication identifiers;
creating privacy barrier for communication transactions, wherein privacy barriers are as per rules defined by the user;
maintaining fine grain control over various transactions as per preferences of the user; and
exercising control before transaction between arbitrary end points that may belong to different trust domains
whereby user gets flexibility to assert an appropriate communication identifier without affecting its principal identity.

2. A method of claim 1, wherein the communication identifiers are part of multiple communication networks, such as circuit switched, packet switched or converged networks.

3. A method of claim 1, further comprising communication identifiers such as email, fax, phone (mobile/landline), pager, voicemail, IM, multimedia, VoIP etc.

4. A method of claim 1, wherein the principal identity is abstract, persistent and universal to the underlying communication identifier, lending complete flexibility to the user to change its communication identifier(s) without affecting its principal identity.

5. A method of claim 1 wherein functionality of local number portability is achieved, which is similarly implemented for various communication identifiers.

6. A method of claim 1, wherein the underlying multiple communication identifiers are hidden from the user(s) and the abstract, persistent, universal, or principal identifier is displayed.

7. A method of claim 1, wherein the user creates privacy barrier and ensures/secures fine grain control over communication transactions wherein such control can be exercised before, during or after communications.

8. A method of claim 1, wherein fine grain control mechanism allows users/appropriate trusted authority to frame/modify/terminate policies, preferences and rules for principal identifier, called commtracts.

9. A method of claim 1, wherein fine grained control and the policies, preferences and rules for principal identifier, can exist in a distributed manner or across networks, channels, media, devices, domains etc.

10. A method of claim 1, wherein the fine grain control extends to inbound and outbound transaction such as access, compliance, expiry, privacy, synchronization and usage of data, versioning, etc.

11. A method of claim 1, wherein user's fine grain control extends to different applications that may employ different communication identifiers.

12. A method of claim 1, wherein user's fine grain control extends to communication contracts or commtracts that are protected, honored and enforced for various communication relationships of a principal identity.

13. A method of claim 8, wherein user's fine grain control extends to communication contracts or commtracts that are protected, honored and enforced for various communication relationships of a principal identity.

14. A method of claim 12, wherein communication contracts or commtracts further comprise of specific logical contracts, permits, access, usage policy, etc. in a system understandable and implementable form.

15. A method of claim 13, wherein communication contracts or commtracts further comprise of specific logical contracts, permits, access, usage policy, etc. in a system understandable and implementable form.

16. A method of claim 12, wherein user's fine grain control extends to communication context, enabling him to share/hide contextual data on a per relationship basis.

17. A method of claim 13, wherein user's fine grain control extends to communication context, enabling him to share/hide contextual data on a per relationship basis.

18. A method of claim 16, wherein communication context further comprises of state, location, preferences, calendar, profile, attributes, relationship etc. in the communication transaction.

19. A method of claim 17, wherein communication context further comprises of state, location, preferences, calendar, profile, attributes, relationship etc. in the communication transaction.

20. A method of claim 16, wherein the preferred channel of communication can be identified based on the temporal context of the user(s).

21. A method of claim 17, wherein the preferred channel of communication can be identified based on the temporal context of the user(s).

22. A method of claim 1 that uses and builds upon existing technologies, such as open standards OASIS, XRI, LAFF 1.2, etc. in the field of communications.

23. A method to provide communication transaction between identities, such method comprising:
contacting by first identity “X” to second identity “Y”;
authenticating for security context X's identity; and
checking for contracts between “X” and “Y” for governing the communication relations between the identities,
corroboration of the temporal context and the rules governing the relationship between the identities
communicating on the designated channel as per the commtracts governing the relationship between the identities,
whereby in absence of any contract/commtract, public or default relationship rules apply, otherwise specific rules defined by users would apply.

24. A method of claim 1 to establish contact on any additional or multiple other channels.

25. A method of claim 23, to establish contact on any additional or multiple other channels.

26. A method of claim 1, to establish fine grain control over the communication transaction in order to control communication spam.

27. A method of claim 23, to establish fine grain control over the communication transaction in order to control communication spam.

28. A method of claim 1, to enable mediated data exchange (or value transfer) between two end-points that belong to different trust domains.

29. A method of claim 23, to enable mediated data exchange (or value transfer) between two end-points that belong to different trust domains.
